(19) United States
(12) Patent Application Publication
(10) Pub. No.: US 2017/0106630 A1
(43) Pub. Date: Apr. 20, 2017

(54) RESIN-RUBBER COMPOSITE

(71) Applicant: NOK Corporation, Tokyo (JP)

(72) Inventor: Akihiro Suzuki, Tottori (JP)

(21) Appl. No.: 15/128,562

(22) PCT Filed: Mar. 12, 2015
(86) PCT No.: PCT/JP2015/057259

§ 371 Date: Sep. 23, 2016

(30) Foreign Application Priority Data
Mar. 28, 2014 (JP) 2014-068719

(51) Int. Cl. B32B 25/08; B29C 65/52; B32B 7/12; B32B 25/12; B32B 25/14; C09J 5/02; B32B 27/28; B29C 65/00; B32B 7/10; C08J 7/12; C08J 7/18; B29C 65/48; B32B 27/34

(52) U.S. Cl. CPC B32B 25/08; B29C 65/483; B29C 65/528; B32B 7/12; B32B 25/12; B32B 25/14; B32B 27/34; B32B 27/286; B29C 66/00143; B32B 7/10; C08J 7/123; C08J 7/18; C09J 5/02; B29K 2677/00

(57) ABSTRACT

A resin-rubber composite in which a polyamide-based resin-molded product or a polyphenylene sulfide-based resin-molded product is directly vulcanization-bonded to a peroxide-crosslinkable nonpolar rubber composition, which forms a rubber layer, without interposing an adhesive, wherein both resin-molded products have a polymerized film with a radical, which is formed by activating the surface of the product, in the case of polyamide-based resin-molded products, by low-pressure plasma treatment by a microwave method using inert gas, or by activating the surface of the product, in the case of polyphenylene sulfide-based resin-molded products, by low-pressure plasma treatment by a microwave method using active gas, and then performing low-pressure plasma treatment by a microwave method using a hydrocarbon-based monomer in both cases. The resin-rubber composite can be effectively used for drum seals, automobile parts such as side cover seals for transmissions, anti-vibration rubber, resin rubber laminate hoses, and the like.

### TECHNICAL FIELD

The present invention relates to a resin-rubber composite. More particularly, the present invention relates to a resin-rubber composite in which a polyamide-based resin-molded product or a polyphenylene sulfide-based resin-molded product and rubber are directly bonded without interposing an adhesive.

### BACKGROUND ART

As a method for forming a resin-molded product, such as those molded from polyamide-based resin, and rubber into a composite, a method that uses an adhesive to bond the resin-molded product and the rubber is generally used. However, the adhesion method using an adhesive has problems not only in that the process is complicated, requiring complicated process management and causing high costs, but also in that it is necessary to use large amounts of environmentally hazardous substances, such as organic solvents.

In contrast, as a method that does not use an adhesive, a method using a rubber compounding that enables the rubber composition to react with a substrate is used. This method does not use an adhesive; however, substrate that can be bonded are limited, and the compounding necessary for bonding may reduce the physical properties of the rubber itself.

Patent Document 1 discloses a resin-rubber laminate in which a polyamide resin that has been subjected to plasma treatment, corona discharge treatment, or ultraviolet irradiation treatment, and a rubber composition containing an alkoxysilane compound of the following formula:

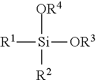

R1, R2: any functional groups
R3, R4: hydrocarbon groups
   are laminated without interposing an adhesive and bonded. However, although natural rubber, ethylene-propylene-diene rubber etc. are mentioned as an example of the rubber to which an alkoxysilane compound is added, the Examples in Patent Document 1 only show sulfur-vulcanizable rubber.

Patent Document 2 discloses a method for combining a polyamide-based resin-molded product and a member comprising other molding materials into a composite without using an adhesive, wherein at least one of these components is treated with an openair plasma on their contact surface prior to the production of the composite, and the other part is then integrally molded.

Here, vulcanized polymer compounds, such as EPDM compound and natural rubber compound, are mentioned as examples of the other molding materials; however, such compounds are molding members (e.g., injection molding member, extrudate, compression molding member), or single- or multilayer films, textile structures, etc., and it is not described that they are unvulcanized rubber compounds.

Moreover, Patent Document 3 discloses a fuel hose comprising an inner resin layer and an outer rubber layer laminated on the outer periphery of the inner resin layer, wherein after the inner resin layer made of polyamide-based resin, fluororesin, or the like is formed by extrusion-molding, and prior to extrusion of the outer rubber layer, the peripheral surface of the inner resin layer is subjected to microwave plasma treatment under reduced pressure. However, EPDM and natural rubber are only mentioned as an example of the extrusion molding rubber forming the outer rubber layer.

Furthermore, Patent Document 4 proposes a method for producing a rubber-based composite material, the method comprising forming a polymerized film having unsaturated bonds on the surface of a substrate by applying low-pressure plasma using a hydrocarbon monomer, and then hot-pressing rubber composition onto the polymerized film to integrate the substrate and the rubber by adhering. The Examples of Patent Document 4 disclose rubber-based composite materials obtained by subjecting a PET sheet, a nylon sheet, a nylon cloth, a stainless-steel plate, etc., to high-frequency plasma treatment in order to form plasma polymerized films thereon, and heat-pressure bonding each of these substrate and a blended rubber composition of sulfur-vulcanizable natural rubber and polyisoprene. However, further improved adhesive strength is desired for all of these rubber-based composite materials.

### PRIOR ART DOCUMENTS

### Patent Documents

Patent Document 1: JP-A-8-72203

Patent Document 2: JP-A-2006-205732

Patent Document 3: JP-A-2008-230244

Patent Document 4: JP-A-3-262636

### OUTLINE OF THE INVENTION

### Problem to be Solved by the Invention

The object of the present invention is to provide a resin-rubber composite in which a resin-molded product and rubber are effectively and directly bonded to each other without interposing an adhesive.

### Means for Solving the Problem

The above object of the present invention can be achieved by a resin-rubber composite in which a polyamide-based resin-molded product or a polyphenylene sulfide-based resin-molded product is directly vulcanization-bonded to a peroxide-crosslinkable nonpolar rubber composition, which forms a rubber layer, without interposing an adhesive, wherein both resin-molded products have a polymerized film with a radical, which is formed by activating the surface of the product, in the case of polyamide-based resin-molded products, by low-pressure plasma treatment by a microwave method using inert gas, or by activating the surface of the product, in the case of polyphenylene sulfide-based resin-molded products, by low-pressure plasma treatment by a microwave method using active gas, and then performing low-pressure plasma treatment by a microwave method using a hydrocarbon-based monomer in both cases.

### Effect of the Invention

The resin-rubber composite of the present invention has the following features:

(1) The formation of a polymerized film on the surface of the resin-molded product by plasma treatment is performed by low-pressure plasma treatment method using microwaves. If the same low-pressure plasma treatment is performed using high frequency, the desired resin-rubber adhesion cannot be ensured.

(2) As shown in Comparative Example 1 which is described later, when a polyimide resin is used in place of polyamide-based resin-molded products or polyphenylene sulfide-based resin, resin-EPDM adhesion can hardly be obtained.

(3) As the rubber to be vulcanization-bonded to the surface of the polyamide-based resin-molded product or the polyphenylene sulfide-based resin, peroxide-crosslinkable nonpolar rubber is used. When sulfur-vulcanizable nonpolar rubber, which is nonpolar rubber having another crosslinkable group, is used, the adhesive strength in the adhesion test is 0 N/mm, and thus the rubber-remaining rate is 0%, as shown in Comparative Examples 10 and 11 which are described later.

(4) When fluororubber or hydrogenated nitrile rubber, each of which is polar rubber, is used as the rubber to be vulcanization-bonded to the surface of the polyamide-based resin-molded product or the polyphenylene sulfide-based resin, even though they are peroxide-crosslinkable, the adhesive strength in the adhesion test is 0.3 to 2.3 N/mm, and the rubber-remaining rate is 0%, as shown in Comparative Examples 12 and 13 which are described later.

### EMBODIMENTS FOR CARRYING OUT THE INVENTION

As the resin to be subjected to microwave low-pressure plasma treatment, a polyamide-based resin or a polyphenylene sulfide-based resin is used. In order to ensure their physical properties, resin to which a filler, such as glass fiber, is suitably added can also be used.

Examples of the type of typical polyamides (PA) and their monomers are as follows:

| | Number of | |
|---|---|---|
| Type | CH₂/NHCO groups | Starting material monomer |
| 46 | 4 | Tetramethylenediamine-adipate |
| 6 | 5 | ε-Caprolactam, ε-aminocaproic acid |
| 66 | 5 | Hexamethylenediamine-adipate |
| 610 | 7 | Hexamethylenediamine-sebacate |
| 612 | 8 | Hexamethylenediamine-dodecanoic |
| | | diacid salt |
| 11 | 10 | ω-Aminoundecanoic acid |
| 12 | 11 | ω-Laurolactam, ω-aminododecanoic acid |

In addition to these polyamides, PA613, 3T, PA810, PA812, PA1010, PA1012, PA1212, PAPACM12, etc., can also be used. These polyamide-based resins are used singly or in combination. Further, they can be used by blending with other resins, such as polypropylene, within the range that does not impair the object.

Polyphenylene sulfide-based resins are classified into three types: a crosslinked type, a partially-crosslinked type, and a linear type. Out of those, the crosslinked type is the lowest-molecular-weight polymer, and the linear type is the highest-molecular-weight polymer. A certain melt viscosity is required for molding materials; therefore, in order to achieve the required melt viscosity, the crosslinked type and the partially-crosslinked type are subjected to oxygen crosslinking by heat treatment. In contrast, the linear type is a polymer originally having a melt viscosity sufficient for molding, even without particularly being subjected to such heat treatment. The weight-average molecular weight Mw of the polymer used in the present invention is about 30,000 to 100,000, preferably about 50,000 to 70,000. Such linear polyphenylene sulfide-based resins of a grade that can be molded are supplied to the market by Tosoh, Kureha, Topuren, etc. In the present invention, such commercial products can be used as they are.

Furthermore, molded products of these resins have a shape that allows vulcanization bonding and lamination of nonpolar rubber to obtain composites. Examples of the shape include a plate shape, a rod shape, a hollow shape, etc., having a flat surface, a curved surface, an irregular surface, or the like. Specific applications thereof are hoses, anti-vibration rubber, and air springs, as well as elements of fuel guiding systems, cooling fluid guiding systems, oil guiding systems, and the like.

First, in order to improve the adhesion with the polymerized film, the outer surfaces of such resin-molded products are activated by plasma treatment using inert gas (e.g., He gas, Ne gas, Ar gas, Kr gas, Xe gas, or N₂ gas) or active gas (e.g., O₂ gas or H₂ gas), singly or as a mixture thereof, before polymerization of a hydrocarbon-based monomer. Here, plasma treatment is performed on the surface of polyamide-based resin preferably using He gas, Ar gas, or N₂ gas singly or as a mixture thereof, and on the surface of polyphenylene sulfide-based resin preferably using O₂ gas. For the plasma treatment, low-pressure plasma treatment by a microwave method is used under the same treatment conditions as those for plasma treatment using a hydrocarbon-based monomer, which is described later.

The resin surface activated by inert gas or active gas is further subjected to low-pressure plasma treatment by a microwave method using a hydrocarbon-based monomer to form a polymerized film. The low-pressure plasma treatment by a microwave method is carried out in a vacuum vessel using a hydrocarbon-based monomer gas as an atmosphere by transmitting microwaves with a frequency of 433 MHz to 2.45 GHz oscillated from a magnetron located in an upper portion of the vacuum chamber to a dielectric surface in the vacuum, thereby exciting the gas on the dielectric surface and forming plasma. As for the conditions for the plasma discharge treatment, it is desirable that the pressure is about 10 to 1,000 Pa, and that the discharge frequency, discharge output, and treatment time are suitably adjusted depending on the shape and size of the treatment device. The treatment is generally performed under conditions where the output is about 10 to 30,000 W, and the time is about 0.1 to 60 minutes.

Any hydrocarbon-based monomer can be used, as long as it is a compound having a radical remaining in the polymerized film after plasma polymerization. Specific examples thereof include aliphatic saturated hydrocarbons, such as methane; aliphatic unsaturated hydrocarbons, such as ethylene, propylene, and acetylene; cyclic hydrocarbons, such as cyclohexene and cyclohexane; and aromatic hydrocarbons, such as styrene and benzene. Preferred among these are acetylene, ethylene, methane, etc. Moreover, such hydrocarbon-based monomer gases can be used singly as they are; however, in terms of the persistence of discharge, stability, and profitability, or the physical properties of the polymerized film to be formed and the like, it is effective to use hydrocarbon-based monomer gas as a component of a gas mixture, along with at least one inert gas, such as He gas, Ar gas, Ne gas, or N₂ gas, in the case of polyamide-based resin-molded products, or along with at least one active gas, such as O₂ gas or H₂ gas, in the case of polyphenylene sulfide-based resin-molded products.

Here, when the plasma treatment is carried out by a high-frequency plasma method that applies high frequency to counter electrodes placed in a vacuum to produce plasma between the electrodes, the desired adhesion effect cannot be obtained.

As the rubber to be bonded to the resin-molded product on which a polymerized film is formed, peroxide-crosslinkable nonpolar rubber is used. Examples of the nonpolar rubber to be crosslinked with peroxide include peroxide-crosslinkable EPDM, natural rubber, ethylene-propylene rubber, butadiene rubber, styrene-butadiene rubber, and the like. Preferred among these are peroxide-crosslinkable EPDM and natural rubber.

As peroxide-crosslinkable EPDM, ethylene-α-olefin-diene copolymerized rubber obtained by copolymerizing ethylene and α-olefin with a small amount of a diene compound, such as 5-ethylidene-2-norbornene, dicyclopentadiene, or 1,4-hexadiene, is used. In practice, commercial products, such as EP22 (produced by JSR), EPT3045 (produced by Mitsui Chemicals), ESPRENE EPDM501A (produced by Sumitomo Chemical), and Buna EPG2440 (produced by Lanxess), can be used as they are.

In addition, examples of the peroxide compound used as a cross-linking agent of rubber include t-butyl peroxide, dicumyl peroxide, t-butyl cumyl peroxide, 1,1-di(t-butyl peroxy)-3,3,5-trimethylcyclohexane, 2,5-dimethyl-2,5-di(t-butylperoxy)hexane, 2,5-dimethyl-2,5-di(t-butylperoxy)hexyne-3, 1,3-di(t-butylperoxyisopropyl)benzene, 2,5-dimethyl-2,5-di(benzoylperoxy)hexane, t-butylperoxy benzoate, t-butylperoxy isopropylcarbonate, n-butyl-4,4′-di(t-butylperoxy)valerate, and the like. The proportion of these cross-linking agent are 0.5 to 10 parts by weight, preferably 0.5 to 6 parts by weight, based on 100 parts by weight of the rubber. If the proportion is less than this range, sufficient crosslinking density is not obtained, and heat resistance, compression set characteristics, etc., are inferior. In contrast, if the proportion is greater than this range, a vulcanization-molded product cannot be obtained due to foaming. Moreover, when the vulcanizable-type is changed to a sulfur-type, desired adhesion with the resin-molded product cannot be obtained.

In the crosslinking of peroxide-crosslinkable nonpolar rubber, it is desirable to use a cocrosslinking agent consisting of a polyfunctional unsaturated compound together with organic peroxide. The polyfunctional unsaturated compound includes, for example, ethyleneglycol di(meth)acrylate, propyleneglycol di(meth)acrylate, triallyl(iso)cyanurate, trimethylolpropane tri(meth)acrylate, triallyl trimellitate, etc. The proportion of these cocrosslinking agent are not more than about 10 parts by weight, preferably about 0.5 to 5 parts by weight, based on 100 parts by weight of the copolymerization rubber.

The peroxide-crosslinkable nonpolar rubber composition comprising the above components as essential components may further contain, if necessary, a reinforcing agent or a filler typified by carbon black or silica, an antioxidant, a plasticizer, a processing aid, a vulcanization aid, etc. These components are kneaded using a closed-type kneader, open roll, or the like.

Vulcanization bonding of peroxide-crosslinkable nonpolar rubber composition to a resin-molded product is performed by directly bonding an unvulcanized nonpolar rubber composition kneaded product to a resin-molded product, followed by molding by a vulcanization molding method, such as injection molding, compression molding, or transfer molding, at about 150 to 200° C. for about 0.5 to 60 minutes, depending on the type of rubber used.

As described above, Patent Document 4 proposes a method in which a polymerized film having unsaturated bonds is formed on the surface of a substrate by low-pressure plasma polymerization of a monomer, and a rubber composition is bonded to the polymerized film by heat-pressure bonding; however, according to this method, there is no limitation on the type of rubber and substrate, and on the plasma treatment method. Further, this method is characterized in that the unsaturated bonds formed on the substrate and the molecules in the rubber are crosslinked with each other. On the other hand, it is an essential requirement for the present invention to select peroxide-crosslinkable nonpolar rubber as the rubber used therein, and low-pressure plasma treatment by a microwave method as the plasma treatment. In addition, it has been confirmed that the radical formed on the polymerized film is crosslinked with the rubber. Therefore, the present invention is significantly different from the invention disclosed in Patent Document 4.

### EXAMPLES

The following describes the present invention with reference to Examples.

### Example 1

A PA66 resin (Amilan CM3001-G30, produced by Toray Industries, Inc.) was used as a polyamide-based resin, and molded into a plate shape (25×60×2 mm) using an injection molding machine. The obtained PA66 resin plate was treated with microwave type low-pressure plasma using a microwave plasma device under helium gas atmosphere at a pressure of about 30 Pa under the following conditions: frequency: 2.45 GHz, output: 500 W, and time: 30 seconds, followed by the PA66 resin plate was treated with microwave type low-pressure plasma under acetylene gas atmosphere at a pressure of about 20 Pa under the following conditions: frequency: 2.45 GHz, output: 300 W, and time: 1 minute.

Subsequently, a kneaded product of an unvulcanized EPDM composition having the following formulation was bonded to the microwave type low-pressure plasma-treated PA66 resin plate, followed by pressure vulcanization at 180° C. for 8 minutes, thereby obtaining a polyamide-based resin-EPDM composite.

[EPDM Composition I]

| | | |
|---|---|---|
| EPDM (EP22, produced by JSR) | 100 | parts by weight |
| HAF carbon black (produced by Cabot Japan | 50 | parts by weight |
| K.K.) | | |
| Stearic acid (produced by Miyoshi Oil & Fat Co., | 1 | part by weight |
| Ltd.) | | |
| Diana Process Oil (PW-380, produced by | 10 | parts by weight |
| Idemitsu Kosan Co., Ltd) | | |
| Zinc oxide (produced by Sakai Chemical Industry | 5 | parts by weight |
| Co., Ltd.) | | |
| Organic Peroxide (Percumyl D, | 3 | parts by weight |
| produced by NOF Corporation) | | |

The obtained polyamide-based resin-EPDM composite was measured for the adhesive strength and rubber-remaining area ratio by a 90-degree peel test according to JIS K6256 (2006) corresponding to ISO 813. As a result, the adhesive strength was 4.0 N/mm, and the rubber-remaining area ratio was 100%.

### Example 2

In Example 1, the low-pressure plasma treatment by a microwave method was performed while ethylene gas was used in place of the acetylene gas as the hydrocarbon-based monomer, and the time of the plasma treatment using the hydrocarbon-based monomer gas was changed from 1 minute to 2 minutes. The adhesive strength of the obtained polyamide-based resin-EPDM composite was 3.9 N/mm, and the rubber-remaining area ratio was 100%.

### Example 3

In Example 1, the low-pressure plasma treatment by a microwave method was performed while methane gas was used in place of the acetylene gas as the hydrocarbon-based monomer, and the output of the plasma treatment using the hydrocarbon-based monomer gas was changed from 300 W to 500 W and the time of treatment was changed from 1 minute to 6 minutes. The adhesive strength of the obtained polyamide-based resin-EPDM composite was 3.9 N/mm, and the rubber-remaining area ratio was 100%.

### Example 4

In Example 1, a polyphenylene sulfide-based resin (Susteel PPS GS-30, produced by Tosoh Corporation) was used in place of the PA66 resin, which is a polyamide-based resin, and O₂ gas was used in place of the He gas. The adhesive strength of the obtained polyphenylene sulfide-based resin-EPDM composite was 3.8 N/mm, and the rubber-remaining area ratio was 100%.

### Example 5

In Example 1, a PA6T (Arlen A335, produced by Mitsui Chemicals, Inc.) was used in place of the PA66 resin as a polyamide-based resin. The adhesive strength of the obtained polyimide-based resin-EPDM composite was 4.3 N/mm, and the rubber-remaining area ratio was 100%.

### Comparative Example 1

In Example 1, a polyimide resin (Arlen JGN3030, produced by Mitsui Chemicals, Inc.) was used in place of the PA66 resin, which is a polyamide-based resin. The adhesive strength of the obtained polyimide-based resin-EPDM composite was 1.1 N/mm, and the rubber-remaining area ratio was 10%.

### Comparative Example 2

In Example 1, a SUS304 steel plate was used in place of the PA66 resin, which is a polyamide-based resin. The adhesive strength of the obtained SUS304 steel plate-EPDM composite was 0 N/mm, and the rubber-remaining area ratio was 0%.

### Comparative Example 3

In Example 1, an aluminum plate was used in place of the PA66 resin, which is a polyamide-based resin. The adhesive strength of the obtained aluminum plate-EPDM composite was 0 N/mm, and the rubber-remaining area ratio was 0%.

### Comparative Example 4

In Example 1, a brass plate was used in place of the PA66 resin, which is a polyamide-based resin. The adhesive strength of the obtained brass plate-EPDM composite was 0 N/mm, and the rubber-remaining area ratio was 0%.

### Comparative Example 5

In Example 1, the PA66 resin, which is a polyamide-based resin, was replaced by a PA66 resin that had been subjected neither to the low-pressure plasma treatment in an helium gas atmosphere nor to the low-pressure plasma treatment in an acetylene gas atmosphere, hence not subjected to surface modification. The adhesive strength of the obtained polyamide-based resin-EPDM composite was 0 N/mm, and the rubber-remaining area ratio was 0%.

### Comparative Example 6

In Example 1, the low-pressure plasma treatment in a helium gas atmosphere was not performed. The adhesive strength of the obtained polyamide-based resin-EPDM composite was 0 N/mm, and the rubber-remaining area ratio was 0%.

### Comparative Example 7

In Example 1, the low-pressure plasma treatment was performed using a glass vacuum vessel provided therein with two Al parallel plates and a PA66 resin plate placed between the two parallel plates, in a helium gas atmosphere at a pressure of about 30 Pa under conditions where the frequency was 40 kHz, the output was 500 W, and the time was 1 minute. Then, the low-pressure plasma treatment was performed by a high-frequency method in an acetylene gas atmosphere at a pressure of about 30 Pa under conditions where the frequency was 40 kHz, the output was 300 W, and the time was 5 minutes. The adhesive strength of the obtained polyamide-based resin-EPDM composite was 0 N/mm, and the rubber-remaining area ratio was 0%.

### Comparative Example 8

In Example 1, a polyphenylene sulfide-based resin was used in place of the PA66 resin, which is a polyamide-based resin. The adhesive strength of the obtained inert gas-treated polyphenylene sulfide-based resin-EPDM composite was 0 N/mm, and the rubber-remaining area ratio was 0%.

### Example 6

In Example 1, a natural rubber composition having the following formulation was used in place of the EPDM composition.

[Natural Rubber Composition I]

| | | |
|---|---|---|
| Natural rubber | 100 | parts by weight |
| HAF carbon black (produced by Cabot Japan | 50 | parts by weight |
| K.K.) | | |
| Stearic acid (produced by Miyoshi Oil & Fat Co., | 2.5 | parts by weight |
| Ltd.) | | |
| Diana Process Oil (PW-380) | 10 | parts by weight |
| Zinc oxide (produced by Sakai Chemical Industry | 3.5 | parts by weight |
| Co., Ltd.) | | |
| Organic Peroxide (Percumyl D) | 3 | parts by weight |

The adhesive strength of the obtained polyamide-based resin-natural rubber composite was 1.5 N/mm, and the rubber-remaining area ratio was 100%.

### Example 7

In Example 6, a polyphenylene sulfide-based resin was used in place of the PA66 resin, which is a polyamide-based resin, and O₂ gas was used in place of the He gas. The adhesive strength of the obtained polyphenylene sulfide-based resin-natural rubber composite was 1.4 N/mm, and the rubber-remaining area ratio was 100%.

### Comparative Example 9

In Example 6, a SUS304 steel plate was used in place of the PA66 resin, which is a polyamide-based resin. The adhesive strength of the obtained SUS304 steel plate-EPDM composite was 0 N/mm, and the rubber-remaining area ratio was 0%.

### Comparative Example 10

In Example 1, a sulfur-vulcanizable EPDM composition having the following formulation was used in place of the peroxide-crosslinkable EPDM composition.

[EPDM Composition II]

| | | |
|---|---|---|
| EPDM (EP33, produced by JSR) | 100 | parts by weight |
| HAF carbon black (produced by Cabot Japan | 60 | parts by weight |
| K.K.) | | |
| Stearic acid (produced by Miyoshi Oil & Fat Co., | 1 | part by weight |
| Ltd.) | | |
| Diana Process Oil (PW-380, produced by | 2 | parts by weight |
| Idemitsu Kosan Co., Ltd) | | |
| Zinc oxide (produced by Sakai Chemical Industry | 5 | parts by weight |
| Co., Ltd.) | | |
| Vulcanization accelerator (Nocceler TT, produced | 1 | part by weight |
| by Ouchi Shinko Chemical Industrial Co., Ltd.) | | |
| Vulcanization accelerator (Nocceler M, produced | 0.5 | parts by weight |
| by Ouchi Shinko Chemical Industrial Co., Ltd.) | | |
| Sulfur | 1.5 | parts by weight |

The adhesive strength of the obtained polyamide-based resin-EPDM composite was 0 N/mm, and the rubber-remaining area ratio was 0%.

### Comparative Example 11

In Example 1, a sulfur-vulcanizable natural rubber composition having the following formulation was used in place of the peroxide-crosslinkable EPDM composition.

[Natural Rubber Composition II]

| | | |
|---|---|---|
| Natural rubber | 100 | parts by weight |
| HAF carbon black (produced by Cabot Japan | 50 | parts by weight |
| K.K.) | | |
| Stearic acid (produced by Miyoshi Oil & Fat Co., | 2.5 | part by weight |
| Ltd.) | | |
| Diana Process Oil (PW-380 produced by | 2 | parts by weight |
| Idemitsu Kosan Co., Ltd) | | |
| Zinc oxide (produced by Sakai Chemical Industry | 8 | parts by weight |
| Co., Ltd.) | | |
| Vulcanization accelerator (Nocceler MSA-G, | 1 | part by weight |
| produced by Ouchi Shinko Chemical Industrial | | |
| Co., Ltd.) | | |
| Sulfur | 6 | parts by weight |

The adhesive strength of the obtained polyamide-based resin-natural rubber composite was 0 N/mm, and the rubber-remaining area ratio was 0%.

### Comparative Example 12

In Example 1, a peroxide-crosslinkable polar fluororubber composition having the following formulation was used in place of the peroxide-crosslinkable nonpolar EPDM composition.

[Fluororubber Composition]

| | | |
|---|---|---|
| Fluororubber (Daiel G901, produced by | 100 | parts by weight |
| Daikin Industries, Ltd.) | | |
| MT carbon black | 20 | parts by weight |
| Magnesium oxide (Magnesia #150, produced by | 6 | parts by weight |
| Kyowa Chemical Industry Co., Ltd.) | | |
| Calcium hydroxide | 3 | parts by weight |
| Triallyl isocyanurate | 1.8 | parts by weight |
| (produced by Nippon Kasei Chemical Co., Ltd.) | | |
| Organic peroxide | 0.8 | parts by weight |
| (Perhexa 25B, produced by NOF Corporation) | | |

The adhesive strength of the obtained polyamide-based resin-fluororubber composite was 2.3 N/mm, but the rubber-remaining area ratio was 0%.

### Comparative Example 13

In Example 1, a peroxide-crosslinkable polar hydrogenated nitrile rubber composition having the following formulation was used in place of the peroxide-crosslinkable nonpolar EPDM composition.

[Hydrogenated nitrile Rubber Composition]

| | | |
|---|---|---|
| Hydrogenated nitrile rubber | 100 | parts by weight |
| (Zetpol 1020, produced by Zeon Corporation) | | |
| HAF carbon black (produced by Cabot Japan | 50 | parts by weight |
| K.K.) | | |
| Stearic acid (produced by Miyoshi Oil & Fat Co., | 0.5 | part by weight |
| Ltd.) | | |
| Zinc oxide (produced by Sakai Chemical Industry | 5 | parts by weight |
| Co., Ltd.) | | |
| Vulcanization accelerator (Nocceler MBZ, | 1 | part by weight |
| produced by Ouchi Shinko Chemical Industrial | | |
| Co., Ltd.) | | |
| Organic Peroxide (Percumyl D) | 3 | parts by weight |

The adhesive strength of the obtained polyamide-based resin-hydrogenated nitrile rubber composite was 0.3 N/mm, and the rubber-remaining area ratio was 0%.

### Comparative Example 14

In Example 1, the low-pressure plasma treatment in an acetylene gas atmosphere was not performed. The adhesive strength of the obtained polyamide-based resin-EPDM composite was 2.3 N/mm, and the rubber-remaining area ratio was 0%.

### Comparative Example 15

In Example 1, O₂ gas was used in place of the He gas, and the low-pressure plasma treatment in an acetylene gas atmosphere was not performed. The adhesive strength of the obtained polyamide-based resin-EPDM composite was 1.5 N/mm, and the rubber-remaining area ratio was 0%.

### Comparative Example 16

In Example 1, a polyphenylene sulfide-based resin (Susteel PPS GS-30) was used in place of the PA66 resin, which is a polyamide-based resin, and the low-pressure plasma treatment in an acetylene gas atmosphere was not performed. The adhesive strength of the obtained polyphenylene sulfide-based resin-EPDM composite was 0 N/mm, and the rubber-remaining area ratio was 0%.

### Comparative Example 17

In Example 4, the low-pressure plasma treatment in an acetylene gas atmosphere was not performed. The adhesive strength of the obtained polyphenylene sulfide-based resin-EPDM composite was 0 N/mm, and the rubber-remaining area ratio was 0%.

### Comparative Example 18

In Example 6, the low-pressure plasma treatment in an acetylene gas atmosphere was not performed. The adhesive strength of the obtained polyamide-based resin-EPDM composite was 0.4 N/mm, and the rubber-remaining area ratio was 0%.

### Comparative Example 19

In Example 6, O₂ gas was used in place of the He gas, and the low-pressure plasma treatment in an acetylene gas atmosphere was not performed. The adhesive strength of the obtained polyamide-based resin-EPDM composite was 0.2 N/mm, and the rubber-remaining area ratio was 0%.

### Comparative Example 20

In Example 6, a polyphenylene sulfide-based resin (Susteel PPS GS-30) was used in place of the PA66 resin, which is a polyamide-based resin, and the low-pressure plasma treatment in an acetylene gas atmosphere was not performed. The adhesive strength of the obtained polyphenylene sulfide-based resin-EPDM composite was 0 N/mm, and the rubber-remaining area ratio was 0%.

### Comparative Example 21

In Example 7, the low-pressure plasma treatment in an acetylene gas atmosphere was not performed. The adhesive strength of the obtained polyphenylene sulfide-based resin-EPDM composite was 0 N/mm, and the rubber-remaining area ratio was 0%.

### INDUSTRIAL APPLICABILITY

The resin-rubber composite of the present invention can be effectively used for drum seals, automobile parts such as side cover seals for transmissions, anti-vibration rubber, resin rubber laminate hoses, and the like.

1. A resin-rubber composite in which a polyamide-based resin-molded product or a polyphenylene sulfide-based resin-molded product is directly vulcanization-bonded to a peroxide-crosslinkable nonpolar rubber composition, which forms a rubber layer, without interposing an adhesive, wherein both resin-molded products have a polymerized film with a radical, which is formed by activating the surface of the product, in the case of polyamide-based resin-molded products, by low-pressure plasma treatment by a microwave method using inert gas, or by activating the surface of the product, in the case of polyphenylene sulfide-based resin-molded products, by low-pressure plasma treatment by a microwave method using active gas, and then performing low-pressure plasma treatment by a microwave method using a hydrocarbon-based monomer in both cases.

2. The resin-rubber composite according to claim 1, wherein the inert gas used to activate the surface of the polyamide-based resin-molded product is helium gas, argon gas, or nitrogen gas.

3. The resin-rubber composite according to claim 1, wherein the active gas used to activate the surface of the polyphenylene sulfide-based resin-molded product is O₂ gas, or H₂ gas.

4. The resin-rubber composite according to claim 1, wherein the hydrocarbon-based monomer used to form a polymerized film with a radical is acetylene, ethylene, or methane.

5. The resin-rubber composite according to claim 1, wherein the peroxide-crosslinkable nonpolar rubber is peroxide-crosslinkable EPDM, natural rubber, ethylene-propylene rubber, butadiene rubber, or styrene-butadiene rubber.
